(19) United States
(12) Patent Application Publication
(10) Pub. No.: US 2012/0185519 A1
(43) Pub. Date: Jul. 19, 2012

(54) Management of Digital Files

(75) Inventor: Philippe Rolland, Cerans-Foulletoutre (FR)

(73) Assignee: ST-Ericsson SA, Plan-les-Ouates (CH)

(21) Appl. No.: 13/499,104

(22) PCT Filed: Sep. 30, 2010
(86) PCT No.: PCT/EP2010/064611

§ 371 Date: Mar. 29, 2012

(30) Foreign Application Priority Data
Sep. 30, 2009 (FR) 09 56791

(51) Int. Cl. G06F 17/30

(52) U.S. Cl. 707/822; 707/E17.01

(57) ABSTRACT

The invention proposes a process for managing digital files wherein a file is organized into content data and file attribute data separate from the content data, and wherein the attribute data comprise a first location datum representing a location of a device that created the file at the moment the file was created and/or a second location datum representing a location of a device that modified the file at the moment the modification was saved.

### TECHNICAL FIELD

This invention relates to the management of digital files, in particular files in portable electronic devices.

### TECHNOLOGICAL BACKGROUND

In the context of the invention, a digital file is a set of binary data stored in the memory of a device, in a given data structure commonly called the “file format”. Digital files are generally managed by an operating system of the electronic device.

A file contains data representing the contents of the file, and properties of the file which are associated with it as file attributes.

From the point of view of the operating system, a file is an object composed of data representing the contents of the file and a set of properties that are associated with it as attributes. In general, the file contents are managed by an application outside the operating system while the attributes are managed and controlled by the operating system.

The file contents can for example represent text, an image, a piece of music, or a computer program. The file properties are for example the size of the file or its contents, the date the file was created, the file format (such as “.doc”, “.jpg”, “mp3”, “.txt”), etc.

Thus the size of the data stored in memory is generally larger than the size of the file. Both the file contents and the file properties (attributes) are stored in memory.

In the prior art, computer applications were proposed for creating “tags” in image files (such as digital photos), in order to include information.

These tags are incorporated into the usable content of the file, and allow applications to read the information they represent without interfering with the normal reading of the content (the image).

In one prior art use, a photographer takes a photo with a digital camera. Back in his studio, the photographer uses software to incorporate a tag into the contents of the file corresponding to his photo, in order to indicate where he took the shot.

However, these applications, known as geotagging applications, have the disadvantage of not all being compatible with each other. A tag introduced with one application may not be readable by another application.

In addition, these applications require user intervention to enter or modify the information contained in the tag. This information may therefore be inaccurate if not entered correctly. Such intervention can also be tedious for the user if he has a large number of files to process.

### SUMMARY OF THE INVENTION

A need therefore exists in file management to have location information associated with a file under conditions that improve the situation.

For this purpose, the invention proposes a process for managing digital files wherein a file is organized into content data and file attribute data separate from the content data, and wherein the attribute data comprise a first location datum representative of a location of a device that created the file at the moment the file was created and/or a second location datum representative of a location of a device that modified the file at the moment the modification was saved.

Thus, at its creation, each file has an attribute related to the place where the file was created and/or to the place where the file was modified.

This attribute can be created at the same time as the file. For example, this attribute is managed by the operating system.

The location attribute (or datum) is therefore independent of the file content, and in particular it is independent of the application used to generate the file. In addition, the location datum is generated in an automatic and reliable manner.

For example, the write access to location data is controlled by an operating system of a device on which the file is stored.

For example, the device is a digital camera, a mobile telephone, a laptop or desktop computer, or other device.

For example, attribute data (or description data, or property data) can be a file creation date, a file author, or other data.

As a further example, the content data correspond to data that the file represents, for example, image, text, video, sound, or other data. Therefore the file created is, for example, an image file, a video file, a text file, an audio file, or some other file. The file can also be an HTML file.

The invention profits in particular from the fact that today's computer systems often have access to a location device.

The second location datum in particular allows updating the location information each time the file is modified.

The location data can be displayed to allow user access. As a further example, the location data can be used by software or an operating system for processing such as searching files, sorting files or data by location criteria (for example geographic criteria), or other processing.

For example, the location data are geolocation data.

In some embodiments, the following steps are implemented by an operating system of a device during the creation of a file:
reserving a first space in a memory unit to store content data of a file and a second space in a memory unit to store attribute data of a file;
obtaining the first location datum; and
storing the first location datum in the second space.

In some embodiments, the following steps are implemented by an operating system of the device during updates to a file:
modifying the file;
updating said file with the modification, by modifying the content data;
obtaining the second location datum; and
updating the attribute data by modifying the second attribute datum.

In these embodiments, the assignment of the location datum is entrusted to an operating system. This ensures the interoperability of the files managed according to the invention, and does so in a manner independent of any particular software application, unlike geotagging for example.

For example, the location data can come from a GPS (Global Positioning System) device.

In some embodiments, a first dedicated field is created for writing the first location datum.

For example, the field is created during the step of reserving the second space in memory.

In some embodiments, a second dedicated field is created for writing the second location datum.

For example, the second field is created during the step of reserving the second space in memory.

The display of a field comprising either the first or second attribute data can also be provided.

The invention also provides for:
a computer program comprising instructions for implementing a process according to the invention, when the program is executed by a processor;
an integrated circuit configured to implement a process according to the invention;
a file management system for implementing a process according to the invention; and
a data structure.

The computer program, the integrated circuit, the system, and the data structure present at least the same advantages as those provided by the process of the invention.

### BRIEF DESCRIPTION OF DRAWINGS

Other features and advantages of the invention will be apparent from reading the following description. This description is purely illustrative and is to be read in light of the attached drawings, in which:

FIG. 1 illustrates a general context for implementing an embodiment of the invention;

FIG. 2 illustrates the structure of a file according to an embodiment of the invention;

FIG. 3 illustrates a system according to an embodiment of the invention;

FIG. 4 is an flow chart of the steps of a process according to an embodiment of the invention; and

FIG. 5 illustrates a display of the contents of a folder in which the files are managed according to an embodiment of the invention.

### DETAILED DESCRIPTION OF EMBODIMENTS

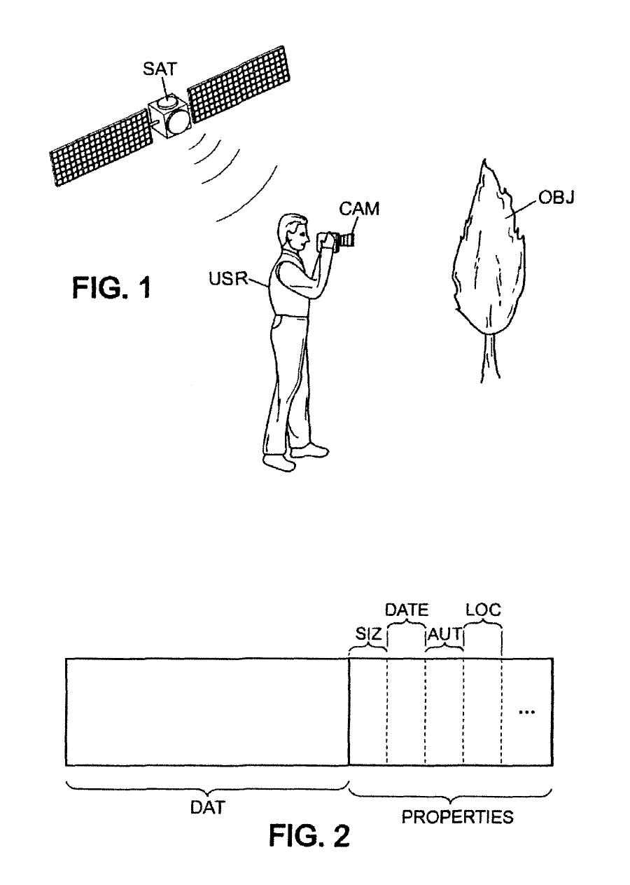

A general context for implementing an embodiment of the invention will now be described with reference to FIG. 1. In this context, a user USR of a digital camera CAM takes a shot of an object OBJ. The digital camera comprises a location device, for example a GPS device, which allows him to obtain from a satellite SAT the longitude, latitude, and altitude of the place where the camera was located when the shot was taken.

During the creation of the file representing the shot, a location datum is attached to the file. When the file is transferred to another device, for example the user's personal computer, it is therefore possible to know the exact location where the shot was taken.

The structure of a file according to an embodiment of the invention is now described with reference to FIG. 2. The file contains two types of data: content data DAT, representing an image for example, and attribute data (or descriptive or property data) PROPERTIES.

The attribute data comprise different fields for different information, in particular:
a file size SIZ, representing for example the size of the content data in bytes,
data DATE indicating the date when the file was created,
data AUT indicating the author of the file. For example, this data identifies the device on which the file was created. As a further example, this data identifies a user of the device or its owner.

The attribute data also comprise data LOC representing the location of the device on which the file was created at the moment it was created. This location therefore corresponds to the time when the file was created.

The attribute data also comprise data (not represented) concerning a location of a place where the file was last modified. The corresponding data field can be updated each time the file is modified.

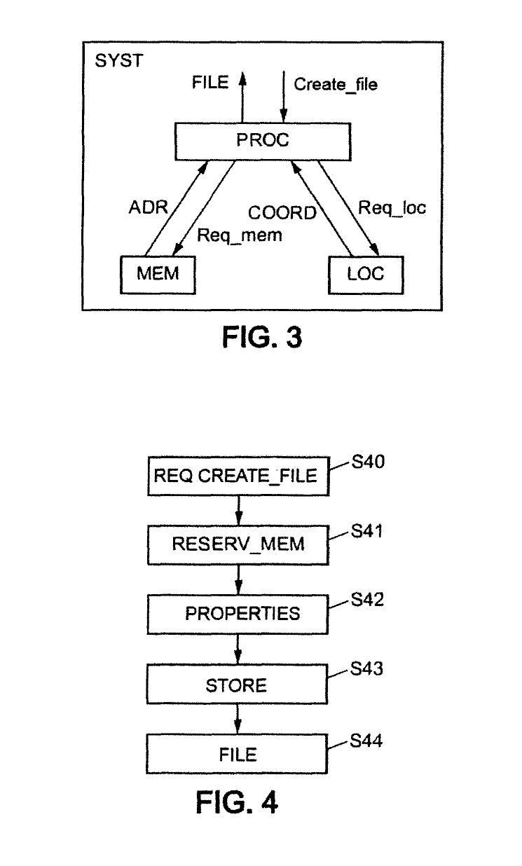

A system and a process according to an embodiment of the invention are now described with reference to FIGS. 3 and 4.

The system SYST represented in FIG. 3 is, for example, a digital camera. The system can also be a computer, a sound recording system, a mobile telephone, or any other device that uses a file manager via an operating system of the device.

The system SYST comprises a processing unit PROC for executing a process of the invention. The system also comprises a memory unit, for storing information such as files or computational data. The memory unit can also comprise a memory for storing a computer program of the invention, for execution by a processor of the processing unit. The system SYST also comprises a location unit for receiving location data for the system, and for providing them to the processing unit. For example, the location unit is a GPS system.

In an embodiment not represented, the location unit is a port for communicating with a GPS system. It is thus possible to plug a GPS system into the system SYST.

During a first step S40, the processing unit receives a file creation request create_file (for example a request to create an image file).

Then, during the step S41, the processing unit sends the memory unit a request to reserve space for storing the file contents and the file attributes.

The memory unit then sends to the processing unit a list of memory addresses ADR available for the file, and reserves the memory space corresponding to the memory addresses.

During the step S42, the processing unit sends the location unit a request req_loc to obtain the location of the system SYST at the time the request create_file was received. In response, the location unit sends to the processing unit a list of information COORD identifying this location. For example, this information is the longitude, latitude, and altitude of the location.

In one variation, the location unit sends a location identifier. For example, instead of sending the longitude, latitude, and altitude of the place where the Eiffel Tower is located, the location unit sends the information “EIFFEL TOWER”. In this variation, the location unit can communicate with a remote server which stores identifiers for special places such as the Eiffel Tower. Users can therefore share descriptions of these places.

Again referring to FIG. 4, when the processing unit has received the location information COORD, it stores this information during the step S43, in a field of the memory reserved for saving the file properties (or description) in the memory unit. For example, the field is identified by a memory address which allows the processing unit to access it and write the data in it.

During this same step S43, the processing unit also stores other attribute data of the file such as the creation date for example, or other data.

During the step S44, the processing unit ends the file creation, storing the contents of the file in the memory reserved in the memory unit for this purpose, and then the processing unit delivers the created file FILE.

The system SYST can also update, in a file for example of the type described with reference to FIG. 2, an attribute data field reserved for indicating a modification location.

For this purpose, when the system modifies the file and receives a request to save the modifications, it obtains from the location unit the location data for the system at the time the save request was received, then records the location data in the field provided for this purpose.

A computer program of the invention can be implemented according to a general algorithm deduced from the general flow chart in FIG. 4 and from the present description.

An integrated circuit of the invention can be realized, by techniques known to a person skilled in the art, so that it can be configured to implement a process of the invention. For example, a system of the invention can be realized in an integrated circuit.

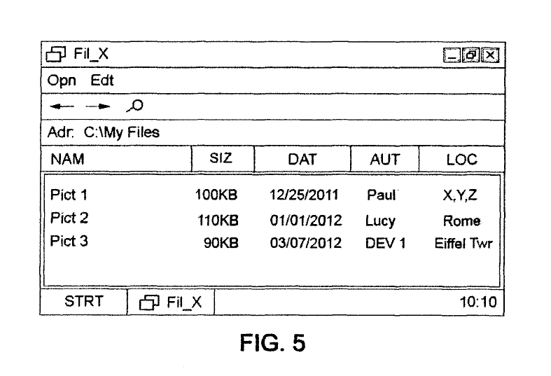

A window for displaying the contents of a folder in which the files are managed according to an embodiment of the invention is now described with reference to FIG. 5. For example, the display window is one in a Windows® environment.

There are various commands in this window for managing the folder, such as commands for accessing menus in a manner known to a person skilled in the art.

The folder is organized into columns. It comprises the columns NAM, SIZ, DAT, AUT, and LOC, respectively indicating the file name, size, creation date, author, and location.

Each line in the folder contains information about a file, and the information corresponds to the folder columns.

Thus, as is illustrated in FIG. 5, the file Pict1 has a size of 100 KB and was created on Dec. 25, 2011 by a user named Paul. When the file Pict1 was created, the device on which it was created (for example a camera) was located at the latitude X, the longitude Y, and the altitude Z.

Still referring to FIG. 5, the file Pict2 has a size of 110 KB and was created on Jan. 1, 2012 by Lucy. The device on which it was created (for example a camera) was located in the city of Rome.

For example, during the creation of the file, the device recognized the GPS coordinates of the city and wrote the city name rather than writing the raw GPS coordinates.

The operating system of the device has, for example, stored during creation of the file the longitude, latitude and altitude as the location information, and for the display, the application handling the folder display has accessed a local or remote database to determine that the information identifies the location corresponding to the city of Rome.

The file Pict3, illustrated in FIG. 5, has a size of 90 KB and was created on Mar. 7, 2012 on the device DEN/1 when it was located near the Eiffel Tower in Paris.

The file Pict3 illustrates in particular that the author of the file can designate a user or a device as the origin of the file.

As is illustrated in FIG. 5, the location of the device that created the file at the moment of file creation can be represented by GPS coordinates, a place name, or the name of a monument found at that location.

In some embodiments, the location represents an address of the device on a network. For example, if the file was created on a mobile telephone, the location can correspond to a cell of the telecommunications network the telephone is using, in which the mobile telephone was located when the file was created.

The address can correspond to any other type of machine address.

The invention has been described and illustrated in the present detailed description and in the Figures. The invention is not limited to the embodiments presented here. Other variations and embodiments can be deduced and implemented by a person skilled in the art upon reading the present description and the attached Figures.

In the claims, the term “comprise” does not exclude other elements or other steps. The indefinite article “a” does not exclude the plural. A single processor or several other units can be used to implement the invention. The different characteristics presented and/or claimed can be advantageously combined. Their presence in the description or in the different claims does not exclude this possibility. The reference labels are not to be taken as limiting the scope of the invention.

1.-15. (canceled)

16. A method for managing digital files, comprising:
organizing a file into separate content data and attribute data, the attribute data comprising at least one of a first location datum representative of a first location where the file was created at the moment the file was created and a second location datum representative of a second location where the file was modified at the moment the modification was saved.

17. The method according to claim 16, further comprising managing the first and second location datums by one or more operating systems.

18. The method according to claim 16, further comprising the following steps, implemented by an operating system of a device when the file is created:
reserving a first space in a memory unit to store the content data of the file and a second space in the memory unit to store the attribute data of the file;
obtaining the first location datum; and
storing the first location datum in the second space in the memory unit.

19. The method according to claim 16, further comprising the following steps, implemented by an operating system of a device when the file is updated:
modifying the content data;
obtaining the second location datum; and
updating the attribute data by modifying the second location datum.

20. The method according to claim 16, wherein the first and second location datums are each geolocation data.

21. The method according to claim 16, further comprising displaying a field comprising one of the first location datum and the second location datum.

22. A computer-readable storage medium that stores computer-executable process steps for managing digital files, said computer-executable process steps causing a computer to perform the steps of:
organizing a file into separate content data and attribute data,
the attribute data comprising at least one of a first location datum representative of a first location where the file was created at the moment the file was created and a second location datum representative of a second location where the file was modified at the moment the modification was saved.

23. An integrated circuit configured to manage digital files, the integrated circuit configured to implement the following steps:
organizing a file into separate content data and attribute data,
the attribute data comprising at least one of a first location datum representative of a first location where the file was created at the moment the file was created and a second location datum representative of a second location where the file was modified at the moment the modification was saved.

24. A file management system comprising:
a file management unit for organizing a file into separate content data and attribute data,
wherein the attribute data comprises at least one of a first location datum representative of a location of a device that created the file at the moment the file was created and a second location datum representative of a location of a device that modified the file at the moment the modification was saved.

25. The system according to claim 24, further comprising an operating system that manages the first location datum and the second location datum.

26. The system according to claim 24, further comprising:
a memory unit; and
a location unit; and
wherein the file management unit is configured to execute an operating system and to perform the following operations when the file is created:
reserving a first space in the memory unit for storing the content data and a second space in the memory unit for storing the attribute data;
obtaining the first location datum from the location unit; and
storing the first location datum in the second space in the memory unit.

27. The system according to claim 24, wherein the file management unit is configured to execute an operating system and to perform the following operations when the file is updated:
modifying the content data;
obtaining the second location datum; and
updating the attribute data by modifying the second location datum.

28. The system according to claim 24, further comprising a display unit for displaying a field comprising one of the first and the second location datum.
